(19) United States
(12) Patent Application Publication
(10) Pub. No.: US 2021/0148768 A1
(43) Pub. Date: May 20, 2021

(54) THERMOCHROMIC PIGMENT

(71) Applicant: Hewlett-Packard Development Company, L.P., Spring, TX (US)

(72) Inventors: Po-Feng Chuang, Taipei City (TW); Shih-Hua Chang, Taipei City (TW); Kun-Hung Lin, Taipei City (TW)

(73) Assignee: Hewlett-Packard Development Company, L.P., Spring, TX (US)

(21) Appl. No.: 17/044,020

(22) PCT Filed: Aug. 9, 2018
(86) PCT No.: PCT/US2018/045952

§ 371 Date: Sep. 30, 2020

(51) Int. Cl. G01K 11/165; B41M 3/00; G09F 9/35; G09F 3/02

(52) U.S. Cl. CPC G01K 11/165; B41M 3/001; G09F 2003/023; G09F 3/02; G09F 2003/0208; G09F 9/35

(57) ABSTRACT

A decoration for a computing device includes at least one thermochromic pigment. The decoration is located next to a heat exhaust port of a computing device to change color based on the heat exhausted by the computing device. Further, a computing device may include a heat exhaust port for dissipating heat, and a decoration coupled to the computing device adjacent to the heat exhaust port. The decoration includes at least one thermochromic pigment to change color based on heat exhausted by the heat exhaust.

### BACKGROUND

Computing devices are ubiquitous throughout many parts of the world and are used in a myriad of different applications and markets. One such application in which computing devices are used includes video gaming which involves interaction with a user interface to generate visual feedback on a video device such as a computer monitor or other display device. Some computing platforms include light sources that serve as decorations or embellishments to the computing device to make the computing device aesthetically pleasing.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device including a decoration, according to an example of the principles described herein.

FIG. 2 is a block diagram of a computing device including a thermochromic pigment, according to an example of the principles described herein.

FIG. 3 is a perspective view of a computing device including a thermochromic pigment, according to an example of the principles described herein.

FIG. 4 is a side, cutaway view of a computing device including a thermochromic pigment, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As mentioned above, in some gaming platforms, light sources may be added to the computing device to provide a more aesthetically pleasing gaming platform. In some examples, these light sources may be light emitting diodes (LEDs). In addition to graphics processing unit (GPU) and other components, these LEDs consume energy in, for example, a laptop battery that may otherwise be used to operate the computing device. Thus, the LEDs shorten the battery life of the computing device.

Further, addition of LEDs in the computing device result in a relatively heavier computing device compared to computing devices that do not have LEDs incorporated therein. Weight in a computing device and especially a laptop computing device is a consideration when manufacturing such devices because users desire, among other characteristics, a light-weight computing device so that the computing device may be easily carried from one place to another without excessive strain. Laptop computing devices used for gaming can be relatively heavier than other laptop computing devices due to the inclusion of the GPU, extra fans to cool the laptop computing device, and the LED.

Examples described herein provide a decoration for a computing device includes at least one thermochromic pigment. The decoration is located next to a heat exhaust port of a computing device to change color based on the heat exhausted by the computing device. The thermochromic pigment may be a leuco dye. The leuco dye is a spirolactone, a fluoran, a spiropyran, a fulgide, or combinations thereof. The thermochromic pigment is a thermochromic liquid crystal. The thermochromic liquid crystal is a cholesteric liquid crystal, a chiral nematic liquid crystal, or combinations thereof. The decoration is located on a display of the computing device and juxtaposition adjacent to the heat exhaust.

Examples described herein also provide a computing device may include a heat exhaust port for dissipating heat, and a decoration coupled to the computing device adjacent to the heat exhaust port. The decoration includes at least one thermochromic pigment to change color based on heat exhausted by the heat exhaust. The computing device may include a display device. The decoration is coupled to the display device, and the heat exhaust dissipates in the direction of the decoration. The computing device may include an adhesive to adhere the thermochromic pigment to the display device. The computing device may include additional heat exhaust ports directed in a direction other than the display device. The additional heat exhaust ports dissipate larger volumes of heated air relative to the heat exhaust port directed at the display device.

Examples described herein also provide a computing device. The computing device may include a display device, a heat exhaust port for dissipating heat toward the display device, and thermochromic pigment coupled to the display device adjacent to the heat exhaust. The thermochromic pigment changes color based on heat exhausted by the heat exhaust. The computing device may include an adhesive material to adhere the thermochromic pigment to the display device. The adhesive material is an adhesive tape may include adhesive deposited on both sides of the adhesive tape, and the thermochromic pigment adhered to a first side of the adhesive tape. The adhesive tape is coupled to the display device via the adhesive deposited on the second side of the adhesive tape. The thermochromic pigment is a leuco dye or a thermochromic liquid crystal. The leuco dye may be a spirolactone, a fluoran, a spiropyran, a fulgide, or combinations thereof. The computing device may include a clamshell form factor where the display device pivots about an axis relative to a base of the computing device.

Examples described herein provide a decoration placed on a computing device to use as a decoration in place of what is more likely to be a heavier and more expensive LED device. The thermochromic decoration is strategically placed on a portion of the display device at which heat exhaust fans are exhausting heat from the computing device onto that portion of the display device at which the decoration is located. The heat from the heat exhaust fans causes the thermochromic decoration to change color.

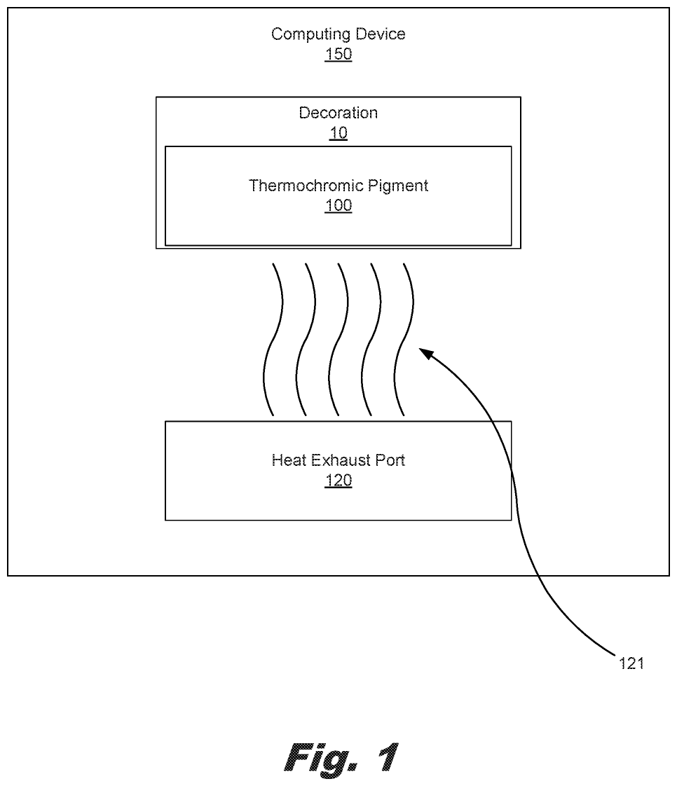

Turning now to the figures, FIG. 1 is a block diagram of a computing device (150) including a decoration (10), according to an example of the principles described herein. The computing device (150) may include a heat exhaust port (120). The heat exhaust port (120) is a fluidic channel from which a heat sink of the computing device (150) dumps its heat (121). A heat sink is any passive and/or active heat exchanger that transfers the heat (121) generated by processors and other electrical and mechanical elements of the computing device (150) to a fluid medium such as, for example, air or a liquid coolant, where it is dissipated away from the computing device (150), thereby allowing regulation of the temperature of the computing device (150) at desired levels. In one example, the heat sink of the computing device (150) may include a heat sink that passively dissipates heat (121), and a fan to push a fluid (i.e., air) across the heat sink. The fan may also push the heated air (121) out the heat exhaust port (120) for use in changing the color of the thermochromic pigment (100).

As described herein, the heat exhaust port may dump the heated fluid (i.e., air) (121) onto the thermochromic pigment (100) of the decoration (10). Thermochromism is the property of a substance to change color as a result of a change in temperature. The thermochromic pigment (100) may be any substance that changes color when exposed to the heat (121) dissipated at the heat exhaust port (120). In one example, the thermochromic pigment (100) may be a leuco dye such as, for example, a spirolactone, a fluoran, a spiropyran, a fulgide, or combinations thereof. Leuco dyes are any dye which can switch between two chemical forms that include two different colors. In one example, one of the chemical forms may be colorless such that the pigment is transparent or translucent and transmits all or most colors. In an example where one of the chemical forms is colorless, the colorless form may be presented by the leuco dye when the leuco dye is at room temperature or is not exposed to a higher temperature such as when heated air (121) from the heat exhaust port (120) is exposed to the leuco dye.

In one example, the leuco dye may be combined with a color developer and a meltable material. This combination of leuco dye, color developer and meltable material may be blended together and microencapsulated within an impervious polymeric wall to produce an aqueous slurry that changes color with a change in the temperature such as from a color to colorless.

In an example, the thermochromic pigment (100) may be a thermochromic liquid crystal. Liquid crystals (LCs) are matter in a state which has properties between those of liquids and those of solid crystals. For example, a liquid crystal may flow like a liquid, but its molecules may be oriented in a crystal-like way. Examples of LCs may include a cholesteric liquid crystal, a chiral nematic liquid crystal, or combinations thereof. In an example, the LCs may be thermotropic LCs that exhibit a phase transition into the liquid-crystal phase as temperature is changed such as when heated air (121) from the heat exhaust port (120) is exposed to the LCs.

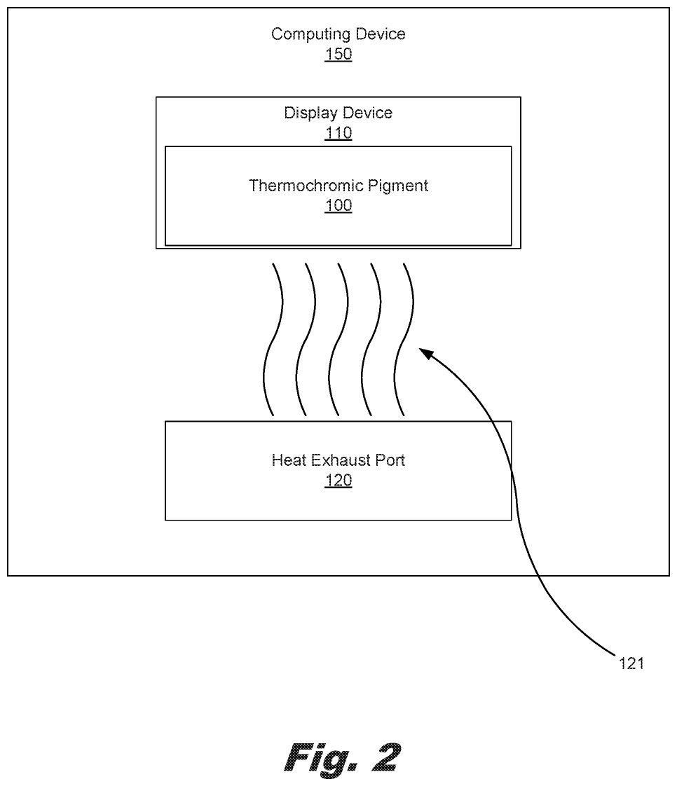

In one example, the decoration (10) may include the thermochromic pigment (100) in the form of a paint or other adherable solution to a portion of the computing device (150). In this example, the paint or other adherable solution may include resins, solvents, and additives along with the thermochromic pigment (100) and the relative amount of the thermochromic pigment (100) included within the paint may be between 1% to 100% thermochromic pigment (100). In another example, the amount of the thermochromic pigment (100) included within the paint may be between a visible amount of thermochromic pigment (100) to an amount of thermochromic pigment (100) that may still allow the thermochromic pigment (100) to be adhered by a functional amount of the paint. As to the application of the thermochromic pigment (100)-containing paint, the paint may be sprayed onto desired portions of the computing device (150) such as, for example, a display device (FIG. 2, 110).

In another example, the thermochromic pigment (100) may be adhered to a backing substrate that is, in turn, adhered to the computing device (150). Adhesives used in these examples may include any substance that binds the thermochromic pigment (100) to the computing device (150) or to a backing substrate and the backing substrate to the computing device (150). Adhesives may include non-reactive adhesives such as, for example, solvent-based adhesives, polymer dispersion adhesives, pressure-sensitive adhesives, contact adhesives, hot-melt adhesives, other non-reactive adhesives, or combinations thereof. Adhesives may include reactive adhesives such as, for example, multi-component adhesives, pre-mixed adhesives, one-part adhesives, other reactive adhesives, and combinations thereof. In an example, the backing substrate may be an adhesive tape where the thermochromic pigment (100) is adhered to one side of the adhesive tape, and the adhesive tape is coupled to a portion of the computing device.

In this example, the thermochromic pigment (100) may be a thermochromic pigment (100)-containing paint described herein, and may be painted onto the backing substrate. The backing substrate may then be adhered to a portion of the computing device (150) such as, for example, a display device (FIG. 2, 110) using the adhesives. The adhesive may be applied to the side of the backing opposite the side on which the thermochromic pigment (100) is deposited. The backing is then coupled to desired portions of the computing device (150) such as, for example, a display device (FIG. 2, 110).

In the examples of thermochromic pigments (100) described herein, the thermochromic pigments (100) may be applied to a portion of the computing device (150) using a screen printing process, a pad printing process, a digitally addressable printhead, other pigment deposition methods, and combinations thereof. Further, in one example, the viscosity of a deposited thermochromic pigment (100) may be diluted using, or example, a paint thinner depending on the method of application of the thermochromic pigment (100).

FIG. 2 is a block diagram of a computing device (150) including a thermochromic pigment (100), according to an example of the principles described herein. Similar elements found in FIG. 1 are also found in FIG. 2, and description relating to these elements is provided herein in connection with FIG. 1. The example of FIG. 2 includes a display device (110). The thermochromic pigment (100) may be coupled to the display device (110) of the computing device (150).

The heat exhaust port (120) that dissipates the heat from the heat creating elements of the computing device (150) may be directed or partially directed to the thermochromic pigment (100) in order to activate the thermochromic properties of the thermochromic pigment (100) and change the color of the thermochromic pigment (100). In one example, the heat exhaust port (120) may be one of a plurality of heat exhaust ports that dump heat from a heat sink of the computing device (150) to the ambient environment. The heat exhaust port (120) may be formed within a housing of the computing device (150) such that the heat (121) sent through the heat exhaust port (120) is directed at the thermochromic pigment (100).

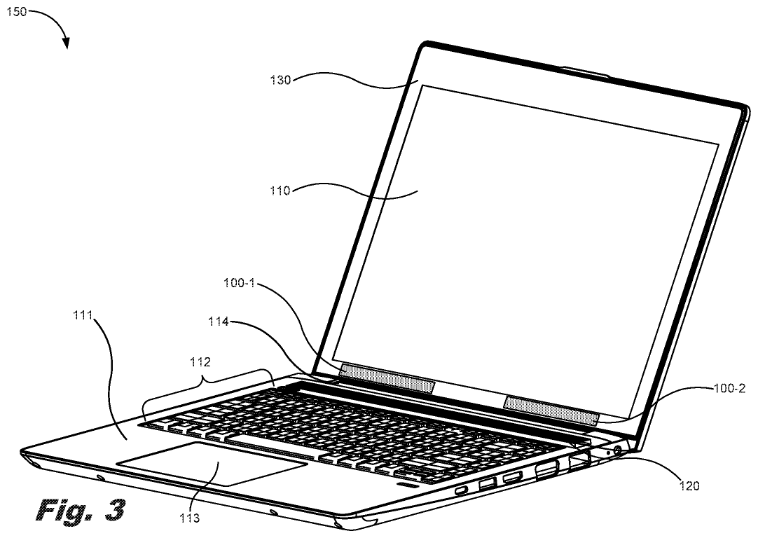

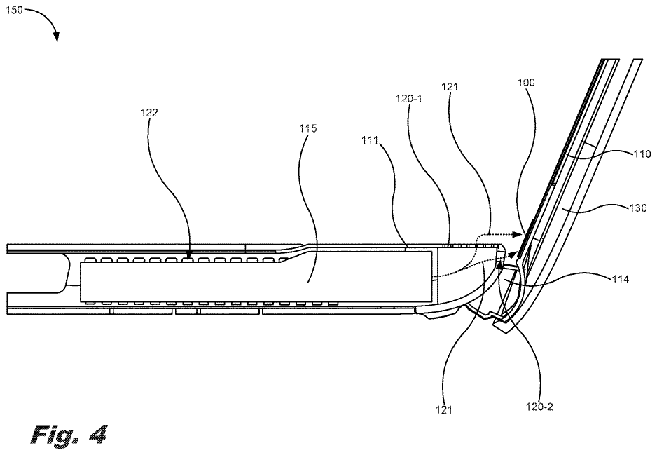

FIG. 3 is a perspective view of a computing device (150) including a thermochromic pigment (100), according to an example of the principles described herein. Further, FIG. 4 is a side, cutaway view of the computing device (150) including a thermochromic pigment (100), according to an example of the principles described herein. The computing device (150) may be manufactured in a clam shell form factor as depicted in FIGS. 3 and 4 where a display device (110) is housed in a first housing (130) and a base (111) that houses a number of computing elements including, for example, a central processing unit (CPU), a graphics processing unit (GPU), memory devices including random access memory (RAM) and read-only memory (ROM), peripheral device adapters, input and output devices such as, for example, a keyboard (112) or a touch pad (113), other hardware devices, and combinations thereof. The first housing (130) and the base (111) are movably coupled to one another using a hinge (114). In this manner, the display device (110) and first housing (130) pivot about an axis relative to the base (111) of the computing device (150).

The computing device (150) may also include a heat sink (115) to dissipate heat from the computing elements of the computing device (150). The heat (120) from the heat sink (115) may be pushed from the heat sink (115) by convection, through the activation of an associated fan, or combinations thereof. The heated air (121) may flow through a first air flow vent (120-1) or a second air flow vent (120-2) as depicted by the arrows depicting the flow of the heat (121) from the heat sink (115). As the heat (121) flows through the first air flow vent (120-1) or a second air flow vent (120-2), the heat (121) heats up the thermochromic pigment (100). Heating of the thermochromic pigment (100) by the heat (121) from the heat sink (115) causes the thermochromic pigment (100) to change color or produce a color according to the type of thermochromic pigment (100) applied to the display device (110).

The thermochromic pigment (100) may be placed on a bottom portion of the first housing (130) below the display device (110) and adjacent to the first air flow vent (120-1) and the second air flow vent (120-2) as depicted in FIGS. 3 and 4. In one example, the thermochromic pigment (100) may be placed anywhere on the first housing (130) where the heat (121) may activate the thermochromic pigment (100).

The activation of the thermochromic pigment (100) causes the aesthetic appeal of the computing device (150) to increase. Further, activation of the thermochromic pigment (100) creates the same effect as the activation of an LED but without the added in space in the computing device (150), added weight to the computing device (150), added cost in manufacturing the computing device (150), and added cost in power consumption that come from the activation of an LED device.

The heat exhaust ports (120-1, 120-2) that dissipates the heat from the heat creating elements of the computing device (150) to the thermochromic pigment (100) in order to activate the thermochromic properties of the thermochromic pigment (100) and change the color of the thermochromic pigment (100) may be numbered among a plurality of heat exhaust ports that dump heat from a heat sink (115) of the computing device (150) to the ambient environment. Additional heat exhaust ports (122) may be defined within the base (111) to allow excess heat to dissipate from the base (111). In this example, the additional heat exhaust ports (122) may be directed in a direction other than towards the display device (110) and/or the thermochromic pigment (100). Further, in an example, the additional heat exhaust ports (122) may dissipate larger volumes of heated air (121) relative to the heat exhaust ports (120-1, 120-2) that direct the heated air (121) toward the thermochromic pigment (100).

The specification and figures describe a decoration for a computing device includes at least one thermochromic pigment. The decoration is located next to a heat exhaust port of a computing device to change color based on the heat exhausted by the computing device. Further, a computing device may include a heat exhaust port for dissipating heat, and a decoration coupled to the computing device adjacent to the heat exhaust port. The decoration includes at least one thermochromic pigment to change color based on heat exhausted by the heat exhaust. Use of a thermochromic pigment provides for the same effect as the activation of an LED but without the added in space in the computing device (150), added weight to the computing device (150), added cost in manufacturing the computing device (150), and added cost in power consumption that come from the activation of an LED device.

The preceding description has been presented to illustrate and describe examples of the principles described. This description is not intended to be exhaustive or to limit these principles to any precise form disclosed. Many modifications and variations are possible in light of the above teaching.

What is claimed is:

1. A decoration for a computing device, comprising:
at least one thermochromic pigment,
wherein the decoration is located next to a heat exhaust port of a computing device to change color based on the heat exhausted by the computing device.

2. The decoration of claim 1, wherein the thermochromic pigment is a leuco dye, wherein the leuco dye is a spirolactone, a fluoran, a spiropyran, a fulgide, or combinations thereof.

3. The decoration of claim 1, wherein the thermochromic pigment is a thermochromic liquid crystal, wherein the thermochromic liquid crystal is a cholesteric liquid crystal, a chiral nematic liquid crystal, or combinations thereof.

4. The decoration of claim 1, wherein the decoration is located on a display of the computing device and adjacent to the heat exhaust.

5. A computing device, comprising:
a heat exhaust port for dissipating heat;
a decoration coupled to the computing device adjacent to the heat exhaust port, the decoration comprising at least one thermochromic pigment to change color based on heat exhausted by the heat exhaust.

6. The computing device of claim 5, comprising a display device,
wherein the decoration is coupled to the display device, and
the heat exhaust dissipates in the direction of the decoration.

7. The computing device of claim 6, comprising an adhesive to adhere the thermochromic pigment to the display device.

8. The computing device of claim 6, comprising additional heat exhaust ports directed in a direction other than the display device.

9. The computing device of claim 5, wherein the additional heat exhaust ports dissipate larger volumes of heated air relative to the heat exhaust port directed at the display device.

10. A computing device, comprising:
a display device;
a heat exhaust port for dissipating heat toward the display device; and
thermochromic pigment coupled to the display device adjacent to the heat exhaust, the thermochromic pigment to change color based on heat exhausted by the heat exhaust.

11. The computing device of claim 10, an adhesive material to adhere the thermochromic pigment to the display device.

12. The computing device of claim 11, wherein the adhesive material is an adhesive tape comprising:
adhesive deposited on both sides of the adhesive tape; and
the thermochromic pigment adhered to a first side of the adhesive tape,
wherein the adhesive tape is coupled to the display device via the adhesive deposited on the second side of the adhesive tape.

13. The computing device of claim 10, wherein the thermochromic pigment is a leuco dye or a thermochromic liquid crystal.

14. The computing device of claim 13, wherein the leuco dye is a spirolactone, a fluoran, a spiropyran, a fulgide, or combinations thereof.

15. The computing device of claim 10, wherein:
the computing device comprises a clamshell form factor, and
the display device pivots about an axis relative to a base of the computing device.
